(19) United States
(12) Patent Application Publication
(10) Pub. No.: US 2026/0140429 A1
(43) Pub. Date: May 21, 2026

(54) IMAGING DEVICE UNIT

(71) Applicant: TOYOTA JIDOSHA KABUSHIKI KAISHA, Toyota-shi (JP)

(72) Inventor: Eisuke IKENO, Toyota-shi (JP)

(73) Assignee: TOYOTA JIDOSHA KABUSHIKI KAISHA, Toyota-shi (JP)

(21) Appl. No.: 19/358,821

(22) Filed: Oct. 15, 2025

(30) Foreign Application Priority Data
Nov. 15, 2024 (JP) 2024-199941

(51) Int. Cl. G03B 17/08; G03B 30/00

(52) U.S. Cl. CPC G03B 17/08; G03B 30/00

(57) ABSTRACT

An imaging device unit is provided on an outside of a vehicle body. The imaging device unit includes a camera including a main body that is fixed to the vehicle body and a lens that is mounted on the main body, a back door garnish portion that covers the camera from above a vehicle, and a protruding portion that is provided outside the camera in a vehicle front-rear direction, protrudes from the back door garnish portion to below the vehicle, and extends in a vehicle width direction. The protruding portion includes a length in the vehicle front-rear direction that decreases toward below the vehicle.

### CROSS-REFERENCE TO RELATED APPLICATION

This application claims priority to Japanese Patent Application No. 2024-199941 filed on November 15, 2024. The disclosure of the above-identified application, including the specification, drawings, and claims, is incorporated by reference herein in its entirety.

### BACKGROUND

### 1. Technical Field

The present disclosure relates to an imaging device unit.

### 2. Description of Related Art

A technique is known in which an imaging device provided in a vehicle images the outside of the vehicle (for example, Japanese Unexamined Patent Application Publication No. 2017-92810 (JP 2017-92810 A)). JP 2017-92810 A discloses a device including an outer wall in which a through hole is provided, and a camera that captures an image rearward of the vehicle through the through hole. In the device, a cover glass is disposed in the through hole, and the camera captures an image rearward of the vehicle through the cover glass. In addition, a canopy portion that surrounds an upper side of the through hole is provided in the outer wall, and the canopy portion blocks raindrops to suppress the raindrops from adhering to the cover glass provided in the through hole.

### SUMMARY

However, with the structure in which the canopy portion is provided in an upper portion of the imaging device (camera), the raindrops falling on the canopy portion may become water droplets, and the droplets may run down a surface of the canopy portion and come into contact with the imaging device. In a case where the water droplets come into contact with the imaging device, the water droplets may enter inside the camera from a gap between the main body of the camera and a lens, or the like, and the camera may be damaged. In addition, the water droplets may adhere to the lens and appropriate imaging may be inhibited.

The present disclosure factors in the above facts, and an object of the present disclosure is to obtain an imaging device unit capable of suppressing contact between water droplets and an imaging device.

An imaging device unit according to an aspect of the present disclosure includes an imaging device provided outside a vehicle body and including a main body fixed to the vehicle body and a lens mounted on the main body, a canopy portion that covers the imaging device from an upper side in a vehicle up-down direction, and a protruding portion that is provided outside the imaging device in a vehicle front-rear direction, the protruding portion protruding from the canopy portion downward in the vehicle up-down direction and extending in a vehicle width direction.

The length of the protruding portion in the vehicle front-rear direction decreases toward a lower side in the vehicle up-down direction.

In the above configuration, there is provided the canopy portion covering the imaging device from the upper side in the vehicle up-down direction. As a result, water droplets (for example, raindrops) toward the imaging device from the upper side are blocked by the canopy portion. Therefore, the contact between the imaging device and the water droplets can be suppressed.

In addition, some of the water droplets blocked by the canopy portion will run down a surface of the canopy portion and move to vertically above the imaging device. Meanwhile, in the above configuration, there is provided the protruding portion provided outside the imaging device in the vehicle front-rear direction, and the protruding portion protrudes from the canopy portion downward in the vehicle up-down direction. As a result, the water droplets running down the surface of the canopy portion are blocked from moving by the protruding portion before reaching a position vertically above the imaging device. The water droplets coming into contact with the protruding portion runs down a surface of the protruding portion to move downward, and fall vertically downward from a lower end of the protruding portion. As described above, the protruding portion can cause the water droplets to fall before the water droplets reach the position vertically above the imaging device, and thus the contact between the imaging device and the water droplets can be suppressed.

As described above, since the contact between the imaging device and the water droplets is suppressed, entry of the water droplets inside the imaging device can be suppressed. In addition, it is possible to make it difficult for the water droplets to adhere to the lens of the imaging device.

In addition, in the above configuration, the length of the protruding portion in the vehicle front-rear direction decreases toward the lower side in the vehicle up-down direction. As a result, it is possible to easily cause the water droplets to fall from the lower end of the protruding portion.

In the above aspect, a lower edge of the protruding portion may include an inclined portion that is inclined such that an inner side of the inclined portion in the vehicle width direction is located on a more upper side in the vehicle up-down direction than an outer side of the inclined portion in the vehicle width direction.

In the above configuration, the lower edge of the protruding portion includes the inclined portion that is inclined such that the inner side of the inclined portion in the vehicle width direction is located on the more upper side in the vehicle up-down direction than the outer side of the inclined portion in the vehicle width direction. As a result, the water droplets running down to the inclined portion of the protruding portion move to the outer side in the vehicle width direction and fall downward. Therefore, it is possible to further suppress the contact between the imaging device and the water droplets.

In the above aspect, the protruding portion may be curved or bent to be located on an inner side in the vehicle front-rear direction toward an outer side in the vehicle width direction from the center in the vehicle width direction.

In the above configuration, the protruding portion is curved or bent to be located on the inner side in the vehicle front-rear direction toward the outer side in the vehicle width direction from the center in the vehicle width direction. As a result, the outer side in the vehicle width direction can be made difficult to be visually recognized from the outside. Therefore, appearance can be improved.

In the above aspect, the length of the protruding portion in the vehicle front-rear direction may decrease toward an outer side in the vehicle width direction.

In the above configuration, the length of the protruding portion in the vehicle front-rear direction decreases toward the outer side in the vehicle width direction. As a result, it is possible to easily cause the water droplets to fall from the lower end of the protruding portion toward the outer side in the vehicle width direction.

As described above, the imaging device unit according to the present disclosure has an excellent effect that the contact between the water droplets and the imaging device can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing a main part of a vehicle to which an imaging device unit according to a first embodiment is applied;

FIG. 2 is a rear view showing a main part of a vehicle to which the imaging device unit according to the first embodiment is applied;

FIG. 3 is an arrow view cross-sectional view taken along III-III line of FIG. 2;

FIG. 4 is a perspective view showing the protruding portion of FIG. 3;

FIG. 5 is a perspective view showing a protruding portion according to a second embodiment;

FIG. 6 is a perspective view showing a protruding portion according to a third embodiment;

FIG. 7 is a front view showing the protruding portion according to the third embodiment; and

FIG. 8 is a perspective view showing a protruding portion according to the fourth embodiment.

### DETAILED DESCRIPTION OF EMBODIMENTS

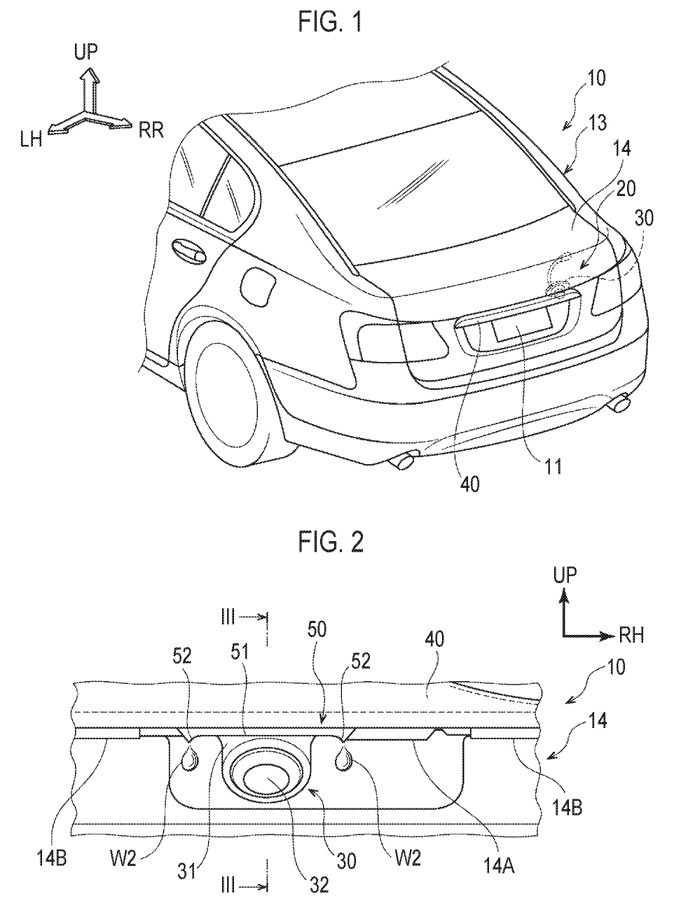

Hereinafter, embodiments of the imaging device unit according to the present disclosure will be described with reference to FIGS. 1 to 8. An arrow FR shown in each of the drawings indicates a front of the vehicle that is a front in a vehicle front-rear direction, and an arrow RR indicates a rear of the vehicle that is a rear in the vehicle front-rear direction. In addition, an arrow LH indicates a left of the vehicle that is a left in the vehicle left-right direction, and an arrow RH indicates a right of the vehicle that is a right in the vehicle left-right direction. In addition, an arrow UP indicates above the vehicle that is an upper side in the vehicle up-down direction. In the following description, a front-rear direction, a left-right direction, and an up-down direction represent a vehicle front-rear direction, a vehicle left-right direction, and a vehicle up-down direction, respectively. In addition, the left-right direction means a left-right direction in a state where the vehicle faces forward.

### First Embodiment

An imaging device unit according to a first embodiment will be described. As shown in FIG. 1, the imaging device unit 20 according to the present embodiment is applied to, for example, a back door 14 provided at a rear portion of a vehicle body 13 that constitutes a vehicle 10. Specifically, the imaging device unit 20 is provided above the license plate 11 of the vehicle that is attached to the back door 14. In addition, the imaging device unit 20 is provided at a center portion in a vehicle width direction.

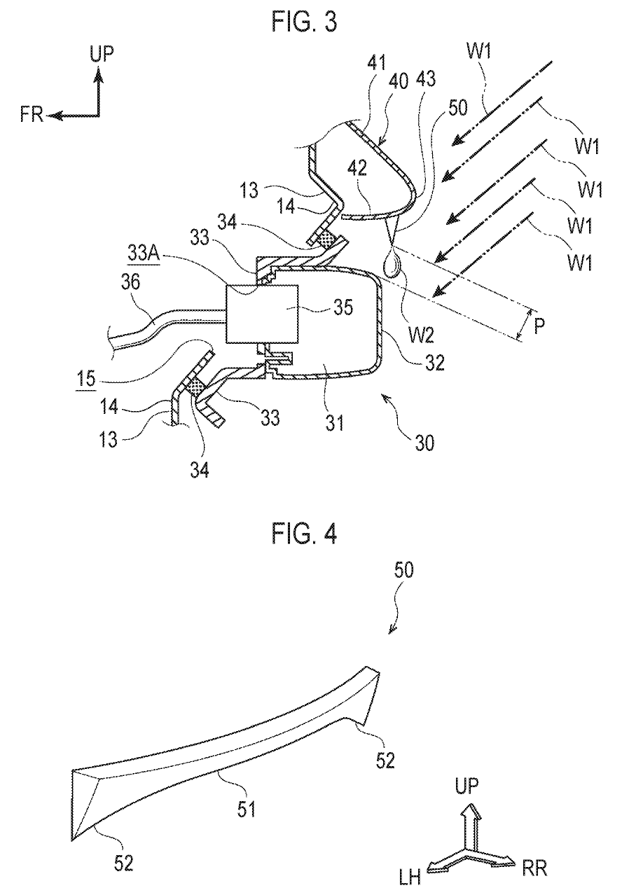

As shown in FIGS. 2 and 3, the imaging device unit 20 includes a camera (imaging device) 30 and a back door garnish portion (canopy portion) 40 provided above the camera 30 of the vehicle. Further, the imaging device unit 20 includes a protruding portion 50 that protrudes downward from a lower surface of the back door garnish portion 40.

As shown in FIG. 2, the camera 30 is mounted on a rear end portion of the vehicle body 13. Specifically, the camera 30 is provided on the left side of the back door opening and closing handle portion 14A of the back door 14 of the vehicle body 13 in the vehicle width direction. In addition, the camera 30 is provided between a pair of license plate irradiation lamps 14B that is separated from each other in the vehicle width direction.

The camera 30 is mounted such that the lens 32 faces behind of the vehicle. The camera 30 is provided outside the vehicle body 13. In other words, the camera 30 is provided to be exposed to the space outside the vehicle. The camera 30 images a rear portion of the vehicle 10. The captured moving image (image) is displayed on, for example, a monitor (not shown) provided in the vehicle cabin.

As shown in FIG. 3, the camera 30 includes a main body 31 fixed to the vehicle body 13 (specifically, the back door 14), a lens 32 mounted on the main body 31, and a fixing portion 33 that fixes the main body 31 to the vehicle body.

The main body 31 houses an imaging element (not shown) or the like inside. A terminal 35 to which a cable 36 is connected is disposed in a front end portion of the main body 31. A lens 32 is mounted on a rear end portion of the main body 31. The terminal 35 and the cable 36 are disposed through the through hole 15 provided in the vehicle body 13 (specifically, the back door 14). The through hole 15 is provided in an inclined portion that is inclined to be front of the vehicle toward a lower side of the vehicle in the back door 14.

The lens 32 is mounted on a rear end portion of the main body 31. For example, the lens 32 is a convex lens and is mounted on the main body 31 to be fitted into an opening provided in the main body 31. The lens 32 is used to image the rear portion of the vehicle 10 and is exposed to the space outside the vehicle 10.

The fixing portion 33 is attached to an edge of the through hole 15 provided in the vehicle body 13 (specifically, the back door 14) via a seal member 34. The fixing portion 33 fixes the main body 31 of the camera 30 to the back door 14. The fixing portion 33 is a plate-shaped member, and a through hole 33A is provided in a center portion in the up-down direction. The main body 31 of the camera 30 is fixed to the fixing portion 33 to close the through hole 33A from behind of the vehicle.

The seal member 34 is provided between an outer surface of the back door 14 and an inner surface of the fixing portion 33. The seal member 34 seals a gap provided between an outer surface of the back door 14 and an inner surface of the fixing portion 33.

As shown in FIGS. 1 and 2, the back door garnish portion 40 is attached to the vehicle body 13 (specifically, the back door 14). The back door garnish portion 40 is provided above the license plate 11 of the vehicle that is attached to the back door 14. In addition, the back door garnish portion 40 extends in a vehicle width direction and is provided at a center portion in the vehicle width direction.

As shown in FIG. 3, the back door garnish portion 40 protrudes from the back door 14 to behind of the vehicle. The back door garnish portion 40 integrally includes an inclined portion 41, a lower surface portion 42, and a curved portion 43. The inclined portion 41 extends from the back door 14 to behind of and below the vehicle. A lower surface portion 42 extends from the back door 14 to behind of the vehicle below the inclined portion 41 of the vehicle. The curved portion 43 connects the distal end of the inclined portion 41 and the distal end of the lower surface portion 42.

The back door garnish portion 40 covers the camera 30 from an upper side of the vehicle. A distal end (a rear end of the vehicle) of the back door garnish portion 40 is located behind of a distal end (a rear end of the vehicle) of the camera 30 of the vehicle. That is, the distal end of the back door garnish portion 40 is located behind of the lens 32 of the camera 30 of the vehicle.

The protruding portion 50 is provided to protrude from the lower end portion of the back door garnish portion 40 to the lower side of the vehicle. The protruding portion 50 is mounted on a lower surface of the lower surface portion 42 of the back door garnish portion 40. As shown in FIG. 2, a part of the protruding portion 50 (specifically, the center portion in the vehicle width direction) overlaps the camera 30 when viewed from the vehicle front-rear direction. Both end portions of the protruding portion 50 in the vehicle width direction do not overlap the camera 30 when viewed from the vehicle front-rear direction.

As shown in FIG. 3, the protruding portion 50 includes a lower end located behind of the camera 30 in the vehicle front-rear direction. The protruding portion 50 includes a lower end located above the camera 30 of the vehicle. A distance P between the lower end of the protruding portion 50 and the rear end of the camera 30 is 5 mm or more.

As shown in FIG. 4, the protruding portion 50 has a length in the vehicle front-rear direction that decreases toward the lower side of the vehicle in an entirety of the region in the vehicle width direction. That is, the protruding portion 50 has a thickness that decreases toward the lower side of the vehicle. In addition, a lower edge of the protruding portion 50 includes a linear portion 51 provided at the center portion in the vehicle width direction and an inclined portion 52 provided at both end portions in the vehicle width direction. The linear portion 51 extends linearly along the vehicle width direction. The inclined portion 52 is inclined such that the inner side in the vehicle width direction is located on the more upper side of the vehicle than the outer side in the vehicle width direction. A curved portion that is curved such that the inner side in the vehicle width direction is located on the more upper side of the vehicle than the outer side in the vehicle width direction may be provided at both end portions of the protruding portion 50 in the vehicle width direction instead of the inclined portion 52.

In addition, the protruding portion 50 is curved to be located closer to the inner side in vehicle front-rear direction (in the present embodiment, the front side in the vehicle front-rear direction) toward both end portions in the vehicle width direction from the center portion in the vehicle width direction.

According to the present embodiment, the following operations and effects can be obtained.

As shown in FIG. 3, in the present embodiment, a back door garnish portion 40 covering the camera 30 from the upper side of the vehicle is provided. As a result, raindrops W1 that fall from above the camera 30 are blocked by the back door garnish portion 40 when it rains or the like. Therefore, the contact between the camera 30 and the raindrop W1 can be suppressed.

In addition, a part of the raindrop W1 blocked by the back door garnish portion 40 becomes a water droplet W2 on the surface of the back door garnish portion 40 and tries to move to the vertical above the camera 30 by running down the surface. On the other hand, in the present embodiment, the protruding portion 50 that is provided behind the camera 30 in the vehicle front-rear direction (in other words, on the outside in the vehicle front-rear direction) and protrudes from the back door garnish portion 40 toward the lower side of the vehicle is provided. As a result, the water droplet W2 running down the surface of the back door garnish portion 40 is blocked from moving by the protruding portion 50 before reaching the position above the camera 30 vertically. The water droplet W2 in contact with the protruding portion 50 moves downward by running down the surface of the protruding portion 50 and falls downward from the lower end of the protruding portion 50 in a vertical direction. As described above, the protruding portion 50 can cause the water droplet W2 to fall before reaching the position above the camera 30 in the vertical direction, and thus the contact between the camera 30 and the water droplet W2 can be suppressed.

Further, as described above, the contact between the camera 30 and the water droplet W2 is suppressed, and thus the entry of the water droplet W2 into the inside of the camera 30 can be suppressed. In addition, the water droplet W2 can be made less likely to adhere to the lens 32 of the camera 30.

In addition, the back door garnish portion 40 covers a gap provided between an outer surface of the back door 14 and an inner surface of the fixing portion 33 from above. Further, the gap provided between the outer surface of the back door 14 and the inner surface of the fixing portion 33 is provided behind of the protruding portion 50 in the vehicle front-rear direction. Therefore, the raindrop W1 and the water droplet W2 are hardly able to reach the gap provided between the outer surface of the back door 14 and the inner surface of the fixing portion 33. Therefore, the situation in which the raindrop W1 or the water droplet W2 enters inside the vehicle body 13 from the gap provided between the outer surface of the back door 14 and the inner surface of the fixing portion 33 can be suppressed. Therefore, for example, the damage to the camera 30 due to the raindrop W1 and the water droplet W2 can be suppressed.

In addition, in the present embodiment, the protruding portion 50 has a length in the vehicle front-rear direction that decreases toward the lower side of the vehicle. As a result, the water droplet W2 can be easily fallen from the lower end of the protruding portion 50.

In addition, in the present embodiment, the lower edge of the protruding portion 50 includes an inclined portion 52 that is inclined such that the inner side in the vehicle width direction is located on the more upper side of the vehicle than the outer side in the vehicle width direction. As a result, the water droplet W2 that has run down to the inclined portion 52 of the protruding portion 50 moves to the outer side in the vehicle width direction and falls downward. In the present embodiment, the inclined portion 52 is provided at both end portions of the lower edge of the protruding portion 50. In addition, both end portions of the protruding portion 50 do not overlap the camera 30 when viewed from the vehicle front-rear direction. Therefore, the water droplet W2 that runs down the protruding portion 50 falls at a position farther from the camera 30. Therefore, the contact between the camera 30 and the water droplet W2 can be suppressed.

### Second Embodiment

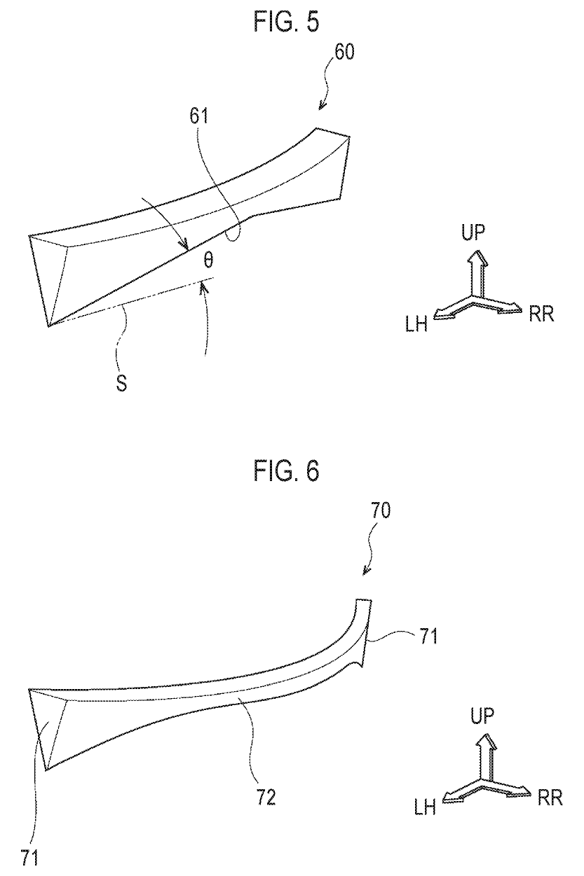

Next, an imaging device unit according to a second embodiment will be described with reference to FIG. 5. The imaging device unit according to the present embodiment has a shape of the protruding portion different from that of the first embodiment. In the following description, solely the points different from the first embodiment will be described, and the same points as the first embodiment will not be described in detail. In addition, the same components as those of the first embodiment are denoted by the same reference numerals.

As shown in FIG. 5, the lower edge of the protruding portion 60 according to the present embodiment is inclined such that the inner side in the vehicle width direction is located on the more upper side of the vehicle than the outer side in the vehicle width direction from the center portion to both end portions in the vehicle width direction. In other words, the lower edge 61 of the protruding portion 60 is inclined such that the center portion in the vehicle width direction is located on the more upper side of the vehicle than both end portions in the vehicle width direction. The lower edge 61 of the protruding portion 60 is a linear inclined portion extending over an entirety of the region in the vehicle width direction.

The inclination angle θ of the lower edge 61 of the protruding portion 60 is set to an angle at which the water droplet W2 can move suitably. The inclination angle θ is an angle between the lower edge 61 of the protruding portion 60 and the horizontal plane S.

According to the present embodiment, the following operations and effects can be obtained.

A lower edge of the protruding portion 60 according to the present embodiment is an inclined portion over an entirety of the region. As a result, the water droplet W2 is more likely to move in the vehicle width direction. Therefore, the water droplet W2 can easily move to a position far from the camera 30, and thus the contact between the camera 30 and the water droplet W2 can be suppressed.

### Third Embodiment

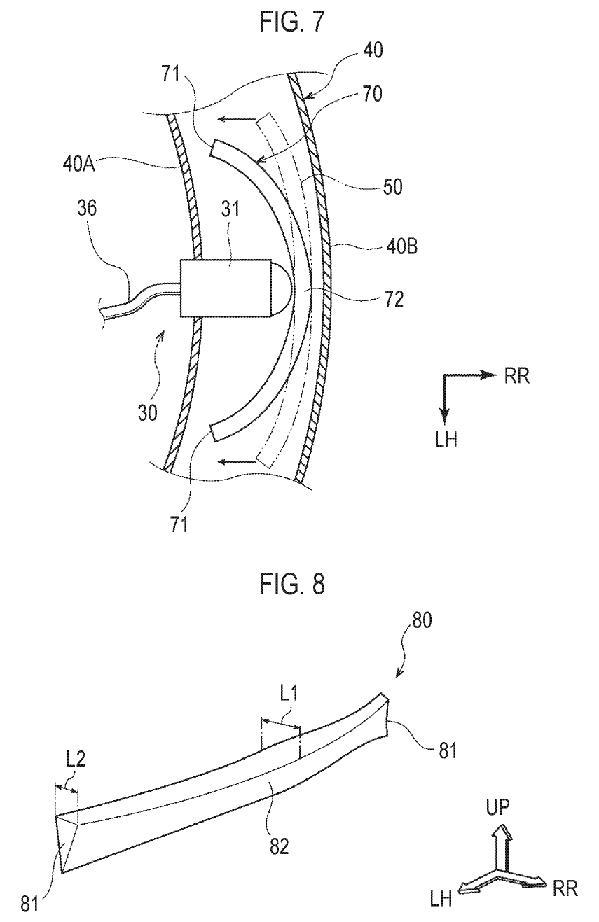

Next, an imaging device unit according to a third embodiment will be described with reference to FIGS. 6 and 7. The imaging device unit according to the present embodiment has a shape of the protruding portion different from that of the first embodiment. In the following description, solely the points different from the first embodiment will be described, and the same points as the first embodiment will not be described in detail. In addition, the same components as those of the first embodiment are denoted by the same reference numerals. In FIG. 7, the protruding portion 50 illustrated by the two-dot chain line is the protruding portion 50 according to the first embodiment.

As shown in FIGS. 6 and 7, the protruding portion 70 according to the present embodiment is curved to be located closer to the inner side in vehicle front-rear direction (in the present embodiment, the front side in the vehicle front-rear direction) toward both end portions 71 in the vehicle width direction from the center portion 72 in the vehicle width direction over an entirety of the region in the vehicle width direction. The protruding portion 70 according to the present embodiment has a radius of curvature larger than the protruding portion 50 according to the first embodiment. As shown in FIG. 7, both end portions 71 of the protruding portion 70 are provided behind of the front end portion 40A of the back door garnish portion 40 in the vehicle front-rear direction. In addition, the protruding portion 70 is curved such that the center portion 72 is closer to the rear end portion 40B of the back door garnish portion 40 than the front end portion 40A, and both end portions 71 are closer to the front end portion 40A of the back door garnish portion 40 than the rear end portion 40B.

According to the present embodiment, the following operations and effects can be obtained.

In the present embodiment, the protruding portion 70 is curved to be located on the front side in the vehicle front-rear direction toward the outer side in the vehicle width direction from the center in the vehicle width direction. As a result, it is possible to make both end portions in the vehicle width direction difficult to be visually recognized from the outside. Therefore, appearance can be improved. In particular, in the present embodiment, the protruding portion 70 is curved such that the center portion 72 is closer to the rear end portion 40B of the back door garnish portion 40 than the front end portion 40A, and both end portions 71 are closer to the front end portion 40A of the back door garnish portion 40 than the rear end portion 40B. That is, the protruding portion 70 is curved such that its radius of curvature is relatively large. As a result, both end portions in the vehicle width direction can be made less visible from the outside. Therefore, the appearance can be further improved.

The protruding portion may be bent to be located on the inner side in the vehicle front-rear direction toward the outer side in the vehicle width direction from the center in the vehicle width direction in an entirety of the region in the vehicle width direction.

### Fourth Embodiment

Next, an imaging device unit according to a fourth embodiment will be described with reference to FIG. 8. The imaging device unit according to the present embodiment has a shape of the protruding portion different from that of the first embodiment. In the following description, solely the points different from the first embodiment will be described, and the same points as the first embodiment will not be described in detail. In addition, the same components as those of the first embodiment are denoted by the same reference numerals.

As shown in FIG. 8, the protruding portion 80 according to the present embodiment has a length L1 of the center portion 82 in the vehicle width direction in the vehicle front-rear direction longer than a length L2 of both end portions 81 in the vehicle width direction in the vehicle front-rear direction on the upper surface. In addition, the protruding portion 80 has a length in the vehicle front-rear direction that decreases toward both end portions 81 in the vehicle width direction from the center portion 82.

According to the present embodiment, the following operations and effects can be obtained.

In the present embodiment, the protruding portion 80 has a length in the vehicle front-rear direction that decreases toward both end portions 81 from the center portion 82. As a result, it is possible to easily cause the water droplets to fall from the lower end of the protruding portion 80 toward both end portions 81.

Although the imaging device unit according to the embodiment has been described above, the present disclosure can be appropriately modified in design within the scope of the present disclosure without departing from the spirit of the present disclosure.

For example, in the above-described embodiment, an example in which the imaging device unit 20 is provided at the rear portion of the vehicle 10 has been described, but the present disclosure is not limited thereto. For example, the imaging device unit 20 may be provided at the front portion of the vehicle 10. In this case, the protruding portion is provided forward of the camera in the vehicle front-rear direction.

In addition, for example, in the above-described embodiment, the example in which the lower edge of the protruding portion 60 is linearly inclined has been described, but the present disclosure is not limited thereto. For example, the lower edge of the protruding portion 60 may be curved such that the inner side of a part or all of the lower edge in the vehicle width direction is located on the more upper side of the vehicle than the outer side in the vehicle width direction.

What is claimed is:

1. An imaging device unit comprising:
an imaging device provided outside a vehicle body and including a main body fixed to the vehicle body and a lens mounted on the main body;
a canopy portion that covers the imaging device from an upper side in a vehicle up-down direction; and
a protruding portion that is provided outside the imaging device in a vehicle front-rear direction, the protruding portion protruding from the canopy portion downward in the vehicle up-down direction and extending in a vehicle width direction,
wherein a length of the protruding portion in the vehicle front-rear direction decreases toward a lower side in the vehicle up-down direction.

2. The imaging device unit according to claim 1, wherein a lower edge of the protruding portion includes an inclined portion that is inclined such that an inner side of the inclined portion in the vehicle width direction is located on a more upper side in the vehicle up-down direction than an outer side of the inclined portion in the vehicle width direction.

3. The imaging device unit according to claim 1, wherein the protruding portion is curved or bent to be located on an inner side in the vehicle front-rear direction toward an outer side in the vehicle width direction from a center in the vehicle width direction.

4. The imaging device unit according to claim 1, wherein the length of the protruding portion in the vehicle front-rear direction decreases toward an outer side in the vehicle width direction.
